(19) United States
(12) Patent Application Publication
(10) Pub. No.: US 2015/0113306 A1
(43) Pub. Date: Apr. 23, 2015

(54) ELECTRIC APPARATUS

(71) Applicant: Sharp Kabushiki Kaisha, Osaka-shi, Osaka (JP)

(72) Inventor: Tatsuaki Amemura, Osaka-shi (JP)

(73) Assignee: Sharp Kabushiki Kaisha, Osaka-shi, Osaka (JP)

(21) Appl. No.: 14/390,144

(22) PCT Filed: Apr. 19, 2013
(86) PCT No.: PCT/JP2013/061577

§ 371 Date: Oct. 2, 2014

(30) Foreign Application Priority Data
Apr. 20, 2012 (JP) 2012-097018

(51) Int. Cl. G06F 1/32

(52) U.S. Cl. CPC G06F 1/3203
USPC 713/323

(57) ABSTRACT

Provided is an electric apparatus capable of preventing a waste of power by performing return depending on a return instruction when any one of return instruction reception units receives a return instruction. A multi-function peripheral having operation states of a power conserving state in which power required for performing functions of the electric apparatus is limited and a normal state in which the power is not limited includes an LAN-Cnt and a home key which receive a return instruction indicating a return to the normal state, and is configured to output a control instruction relating to the return depending on that which one of the LAN-Cnt and the home key receives the return instruction.

This non-provisional application is a National Stage entry under U.S.C. §371 of International Application No. PCT/JP2013/061577 filed on Apr. 19, 2013, which claims priority to Japanese Patent Application No. 2012-097018 filed in Japan on Apr. 20, 2012. The entire contents of all of the above applications are hereby incorporated by reference.

### BACKGROUND

1. Technical Field

The present invention relates to an electric apparatus which has operation states of a power conserving state in which power required for performing functions of the electric apparatus is limited and a normal state in which the power is not limited.

2. Description of Related Art

Recently, to protect energy resources, prevent air pollution, and the like, the development of energy conserving products has been progressed. For example, many electric apparatus are provided with a so-called power conserving function for shifting a normal mode to a power conserving (sleep) mode which is capable of reducing power consumption when they are not operated for a prescribed time or when a prescribed button is operated by a user.

Further, in connection with the electric apparatus having the power saving function, Japanese Patent Laid-open Publication No. 11-345205 discloses a computer system which checks a wake-up factor if the electric apparatus is woken up to return from a sleep state to a normal state, and when the wake-up factor is a wake-up signal from a LAN controller, returns to the normal state in which a display screen of a display monitor such as an LCD is blanked (turned off) or an input by a keyboard and a mouse is locked, and thereby it is possible to prevent the leakage of secret information to a third party or a fraudulent manipulation by the third party even if the electric apparatus has begun to be operated remotely in an unmanned state at night.

### SUMMARY

Meanwhile, as described above, many electric apparatuses having the power conserving function display a home screen (initial screen), and the like when returning from the sleep mode to the normal state. For example, when the electric apparatus returns to the normal state by the operation of the user, there is a need to display the home screen to receive an instruction relating to any function from the user.

However, when the electric apparatus returns from the sleep mode on account of circumstances of the electric apparatus, such as a transmission of a periodical log signal, a reception of a firmware update signal, or the like, there is no need to display the screen and a waste of power is caused. Further, a screen is suddenly displayed in an unmanned state and thus persons around the apparatus are likely to feel that this is abnormal.

However, the computer system of Japanese Patent Laid-open Publication No. 11-345205 does not consider the above problems and may not solve these problems.

In consideration of the above-mentioned circumstances, it is an object of the present invention to provide an electric apparatus having operation states of a power conserving state in which power required for performing functions of the electric apparatus is limited and a normal state in which the power is not limited, wherein the electric apparatus includes a plurality of return instruction reception units for receiving a return instruction indicating a return to the normal state, and is configured to output a control instruction relating to the return depending on that which one of the return instruction reception units receives the return instruction to perform a control relating to the return depending on the return instruction when any one of the return instruction reception units receives the return instruction, thereby performing the appropriate return from case to case to prevent, for example, a waste of power, and the like as described above.

According to the present invention, there is provided an electric apparatus having operation states of a power conserving state in which power required for performing functions of the electric apparatus is limited and a normal state in which the power is not limited, the electric apparatus including: a plurality of return instruction reception units configured to receive a return instruction indicating a return to the normal state; and a control instruction output unit configured to output a control instruction relating to the return depending on which one of the return instruction reception units receives the return instruction.

According to the present invention, the control instruction output unit outputs the control instruction relating to the return depending on that which one of the plurality of return instruction reception units receives the return instruction, and therefore when any one of the return instruction reception units receives a prescribed return instruction, performs the control relating to the return depending on the return instruction to appropriately return to the normal state in that occasion.

The electric apparatus according to the present invention may include: a signal reception unit configured to receive signals from some of the plurality of return instruction reception units, wherein the control instruction output unit may have two input terminals to which the signal from the signal reception unit is input, and the remaining return instruction reception units may be connected to one of the two input terminals.

According to the present invention, some of the plurality of return instruction reception units are connected to the two input terminals of the control instruction output unit through the signal reception unit, and the remaining return instruction reception units are connected only to one of the two input terminals. Therefore, the control instruction output unit may output the control instruction relating to the return depending on that which one of the plurality of return instruction reception units receives the return instruction based on the signals relating to the two input terminals, for example, the level of the signals.

In the electric apparatus according to the present invention, the control instruction output unit may be configured to output the control instruction based on the signal input to the other input terminal of the two input terminals when any one of the return instruction reception units receives the return instruction.

According to the present invention, the control instruction output unit outputs the control instruction based on the signal input to the other input terminal of the two input terminals, for example, the level of the signal when any one of the return instruction reception units receives the return instruction.

In the electric apparatus according to the present invention, the signal reception unit may have a signal holding unit configured to hold a signal to be output to the other input terminal.

According to the present invention, the signal holding unit of the signal reception unit temporarily holds the signal to be output to the other input terminal. Therefore, for example, even when the signal is input to the signal reception unit through a tact switch which cannot hold turn on and/or off states, an output to the other input terminal is secured, and therefore the control instruction output unit may stably output the control instruction based on the signal input to the other input terminal.

In the electric apparatus according to the present invention, some of the return instruction reception units may be configured to receive an instruction relating to execution of the functions.

According to the present invention, the some of the return instruction reception units are configured to receive the return instruction indicating a return to the normal state and to also play a role of a reception unit receiving the instruction relating to the execution of the functions from the user.

According to the present invention, the electric apparatus may include the plurality of return instruction reception units for receiving the return instruction indicating a return to the normal state and may output the control instruction relating to the return depending on that which one of the return instruction reception units receives the return instruction to perform the control relating to the return depending on the return instruction, when any one of the return instruction reception units receives the return instruction, and thereby performing the appropriate return from case to case to prevent, for example, a waste of power, or the like as described above.

The above and further objects and features will move fully be apparent from the following detailed description with accompanying drawings.

### BRIEF DESCRIPTION OF THE SEVERAL VIEWS OF THE DRAWINGS

FIG. 1 is a functional block diagram illustrating a configuration of main components of a multi-function peripheral according to an embodiment of the present invention.

FIG. 2 is a functional block diagram illustrating a configuration of main components of a control unit in the multi-function peripheral according to the embodiment of the present invention.

FIG. 3 is an explanatory diagram describing a connection relation between a CPLD, a south bridge, and an SOC in the multi-function peripheral according to the embodiment of the present invention.

FIG. 4 is a flow chart describing processing when a LAN-Cnt receives a Magic-Packet in the multi-function peripheral according to the embodiment of the present invention.

FIG. 5 is a flow chart describing processing when a user operates any one of hardware keys of an operation panel at the time of a power conserving mode in the multi-function peripheral according to the embodiment of the present invention.

### DETAILED DESCRIPTION

Hereinafter, a case in which an electric apparatus according to an embodiment of the present invention is applied to a multi-function peripheral will be described in detail, by way of example, with reference to the accompanying drawings. The multi-function peripheral has a function of a scanner, a facsimile, a printer and the like.

The multi-function peripheral according to the embodiment of the present invention has operation modes (operation states) of a power conserving mode (power conserving state) and a standby mode (normal state). In the power conserving mode, a supply of power to parts relating to the execution of functions of the multi-function peripheral is limited and thus power consumption is reduced. Further, in the standby mode, power is supplied to the parts in which the supply of power has been limited, such that prescribed functions may be immediately performed according to an instruction from a user.

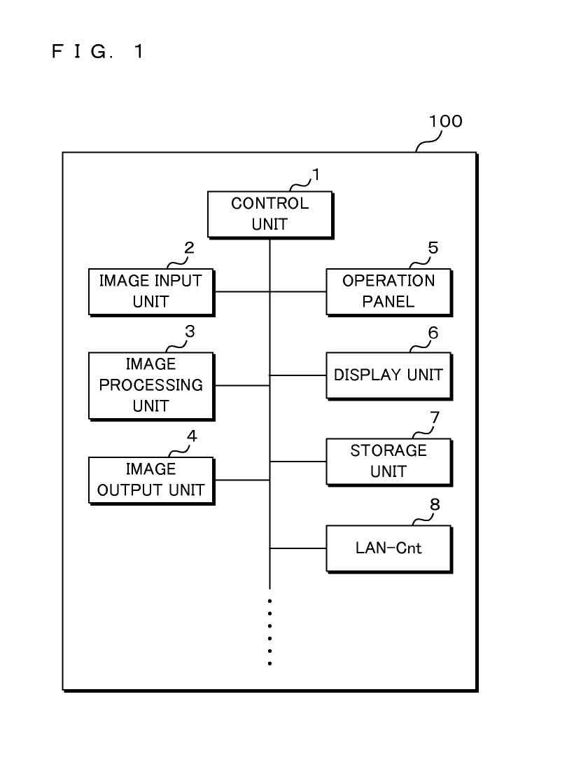

FIG. 1 is a functional block diagram illustrating a configuration of main components of a multi-function peripheral 100 according to an embodiment of the present invention. The multi-function peripheral 100 includes a control unit 1, an image input unit 2, an image processing unit 3, an image output unit 4, an operation panel 5, a display unit 6, a storage unit 7, a LAN-Cnt 8 and the like.

The image input unit 2 includes a light source irradiating light to a manuscript for reading, an image sensor such as a charge coupled device (CCD), or the like, and optically reads image data of the manuscript. Further, the image input unit 2 forms an optical image reflected from the manuscript set at a prescribed read position on the image sensor to output analog data of red-green-blue (RGB).

The image processing unit 3 generates, for example, digital type image data based on the analog data input from the image input unit 2 or reads the image data stored in the storage unit 7, performs processing depending on each type of images, and then generates image data to be output (printed). The image data for outputting generated by the image processing unit 3 is output to the image output unit 4.

The image output unit 4 prints an image on a recording medium such as recording paper, an OHP film, or the like based on the image data output from the image processing unit 3. The image output unit 4 includes a photosensitive drum, a charger for charging the photosensitive drum to a prescribed potential, a laser writing device which emits a laser beam depending on the image data received from an outside to generate an electrostatic latent image on the photosensitive drum, a developing device which supplies a toner to the electrostatic latent image formed on a surface of the photosensitive drum to develop the image, a transfer unit which transfers a toner image formed on the surface of the photosensitive drum onto the recording medium, and forms the image on the recording medium by an electro-photographic method.

Further, in the multi-function peripheral 100, the operation panel 5 is provided with hardware keys, such as a function key for switching functions such as “facsimile”, “copy”, “printing”, “mail”, and the like, a start key, a cancel key, an enter key for fixing a received instruction, and a home key for returning a display screen of the display unit 6 to a home screen receiving a selection of any one of functions included in the multi-function peripheral 100.

The display unit 6 includes, for example, an LCD, an electroluminescence (EL) panel, or the like and displays an image to be output (printed) on a prescribed recording paper through the image output unit 4. Further, the display unit 6 displays information to be notified to the user, such as a state of the multi-function peripheral 100, a job processing situation, an image of a manuscript read by the image input unit 2, and a confirmation of an operation content of the operation panel 5 and the like.

The storage unit 7 includes, for example, a non-volatile storage medium such as a flash memory, an EEPROM, an HDD, a magneto-resistive memory (MRAM), a ferroelectric RAM (FeRAM), an OUM or the like.

The LAN-Cnt 8 controls a signal transmitted through a network interface (not illustrated) from the outside of the multi-function peripheral 100. For example, when the LAN-Cnt 8 receives a so-called “Magic-Packet” for inputting power to a device controlling the power through, for example, a LAN, the LAN-Cnt 8 outputs a prescribed signal for returning the multi-function peripheral 100 to the standby mode. In other words, the LAN-Cnt 8 plays a role of a return instruction reception unit described in the claims.

In addition, when any one of the hardware keys provided in the operation panel 5 is selectively operated by the user in the power conserving mode, the multi-function peripheral 100 according to the embodiment of the present invention is configured to receive the operation as an instruction to return the multi-function peripheral 100 to the standby mode. In other words, the operation panel 5 (hardware key) is configured to play a role of the return instruction reception unit described in the claims in the power conserving mode.

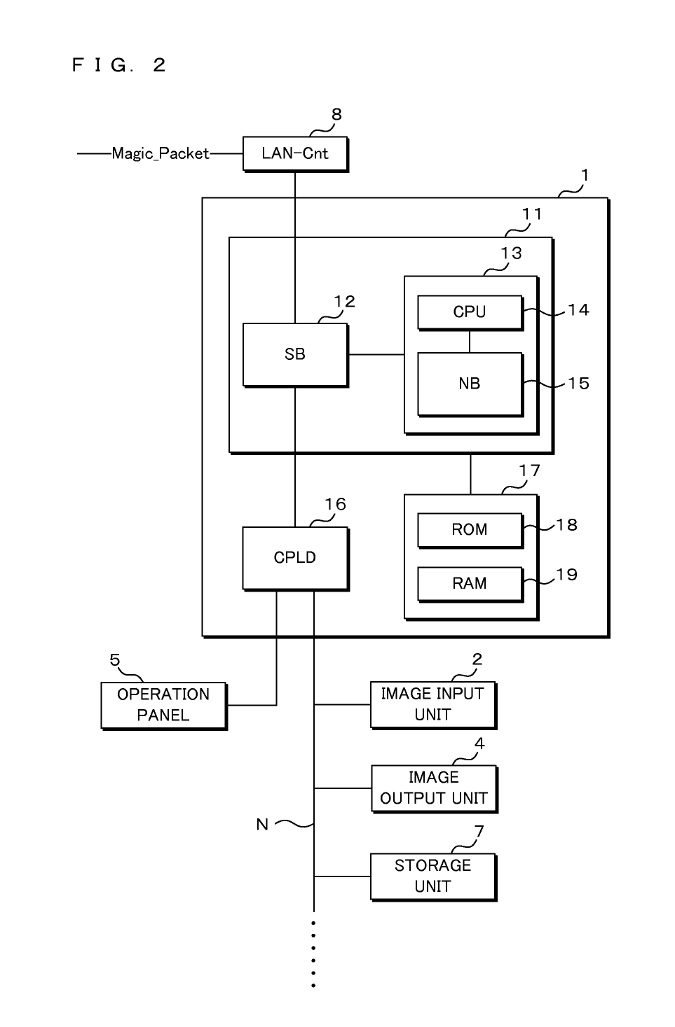

FIG. 2 is a functional block diagram illustrating a configuration of main components of the control unit 1 in the multi-function peripheral 100 according to the embodiment of the present invention.

The control unit 1 includes a control instruction output unit 11, a complex programmable logic device (CPLD) 16, and a system memory 17. The control instruction output unit 11 has a system on chip (SOC) 13 in which a south bridge (SB) 12, a CPU 14, and a north bridge (NB) 15 are integrated as a single chip. Further, the system memory 17 includes a ROM 18 and a RAM 19.

The control instruction output unit 11 and the CPLD 16 play a role of the control instruction output unit and the signal reception unit described in the claims, respectively.

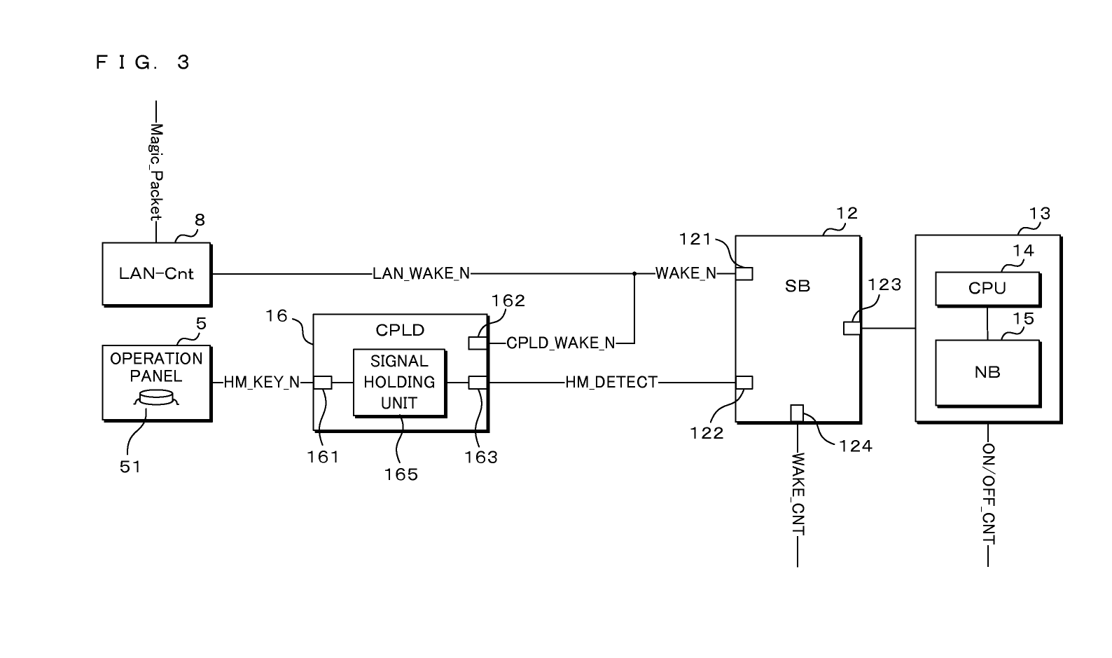

FIG. 3 is an explanatory diagram describing a connection relation between the CPLD 16, the south bridge 12, and the SOC 13 in the multi-function peripheral 100 according to the embodiment of the present invention.

The CPLD 16 is a programmable logic unit which is an electrical circuit having a structure capable of being modified by programming and is connected to the image input unit 2, the image output unit 4, the storage unit 7, the operation panel 5 and the like. The CPLD 16 is equipped with wirings connected to these circuits and is connected thereto through a PCI bus N.

The CPLD 16, in particular, allows the control unit 1 to perform a sequence control. For example, the CPLD 16 controls mode shifting based on the prescribed signal from the south bridge 12 and performs a change in a connection destination of a signal, a signal output, and the like in accordance with each mode.

Further, the CPLD 16 has an input terminal 161 to which a signal output from the hardware key of the operation panel 5 is input. That is, the hardware key of the operation panel 5 is included in the some of the return instruction reception units described in the claims.

Further, the CPLD 16 has an output terminal 162 and an output terminal 163 which output signals to the south bridge 12 depending on the signal input to the input terminal 161. A signal holding unit 165 is connected to the output terminal 163 and the signal output to the south bridge 12 through the output terminal 163 is temporarily held by the signal holding unit 165. The signal holding unit 165 configured by using, for example, a latch circuit is well known in the art, and therefore will not be described in detail.

Depending on a level of the signal input through the input terminal 161, the CPLD 16 outputs the same level of signals to the south bridge 12 through the output terminals 162 and 163, respectively.

The south bridge 12 plays a role of a so-called “chip set” for controlling a flow of signals within the control unit 1. Further, the south bridge 12 serves to connect the PCI bus N with an ISA bus.

The south bridge 12, in particular, outputs a signal which is to be a trigger of the mode shifting. For example, the south bridge 12 outputs a “WAKE_CNT” signal which is a trigger signal in the return from the power conserving mode to the standby mode.

Specifically, the south bridge 12 has an input terminal 121 (one input terminal) and an input terminal 122 (the other input terminal) each corresponding to the output terminal 162 and the output terminal 163 of the CPLD 16, and has an output terminal 123 for outputting a signal to the SOC 13 and an output terminal 124 for outputting a signal to a power supply circuit (for example, DCDC) of hardware relating to each above-described function. The “WAKE_CNT” signal is output to the power supply circuit through the output terminal 124.

Meanwhile, the signal output from the LAN-Cnt 8 is configured to be directly input only to the input terminal 121 of the south bridge 12, without passing through the CPLD 16. That is, the LAN-Cnt 8 is included in the remaining return instruction reception unit described in the claims.

The north bridge 15 has a function as a memory controller and a graphic processing unit (GPU) and similar to the south bridge 12, plays a role of a so-called “chip set” for controlling the flow of signals within the control unit 1. Further, the north bridge 15 serves to connect the CPU 14 with the PCI bus N.

The ROM 18 is basically pre-stored with various control programs, fixed data among parameters for operation, and the like, and the RAM 19 temporarily stores data and reads the data independent of a storage order, a storage position or the like. Further, the RAM 19 stores, for example, programs read from the ROM 18, various data generated by running the programs, parameters appropriately changed at the time of running and the like.

The CPU 14 loads and runs a control program pre-stored in the ROM 18 onto the RAM 19 to control various types of the above-described hardware and operates the overall apparatus as the multi-function peripheral 100 according to the present invention.

Further, the CPU 14 detects the level of the signal input to the input terminal 122 of the south bridge 12 through the output terminal 123 of the south bridge 12, and outputs the control instruction (signal) relating to the return to the standby mode based on the level of the detected signal.

In more detail, the CPU 14 detects the level of the signal which is input to the input terminal 161 of the CPLD 16 to be held in the signal holding unit 165, and is input to the input terminal 122 of the south bridge 12 through the output terminal 13 of the CPLD 16.

The control instruction (hereinafter, referred to as a control instruction at return) relating to the return to the standby mode may be, for example, a starting limit of the specific hardware, and the specific hardware may be the image input unit 2, the operation panel 5, the display unit 6 or the like.

For example, in case of transmission a periodical log signal, reception a firmware update signal, reception a facsimile signal, and the like, only the hardware relating to the processing of the signal is enough to start and the start (return) of the image input unit 2, the display unit 6, and the like is not required, which will cause a waste of power. Therefore, in the return in this case, it is preferable to limit the starting of the specific hardware.

Meanwhile, at the time of the power conserving mode, when any one of the hardware keys of the operation panel 5 is operated by the user, each hardware key receives the operation as the instruction to return the multi-function peripheral 100 to the standby mode. In this case, since all the hardware units need to start (return) for receiving the instruction relating to the prescribed function from the user, the starting limit as described above is unnecessary.

Therefore, in the multi-function peripheral 100 according to the present invention, the CPU 14 detects the level of the signal input to the input terminal 122 of the south bridge 12, and the SOC 13 (CPU 14) appropriately outputs the control instruction at return based on the detected result. Hereinafter, for the convenience of explanation, the case of limiting the starting of the display unit 6 will be described by way of example. That is, the instruction signal “ON/OFF_CNT” relating to whether the starting of the display unit 6 is limited, is output from the SOC 13 to the power supply circuit of the display unit 6 based on the detected result of the level of the signal by the CPU 14.

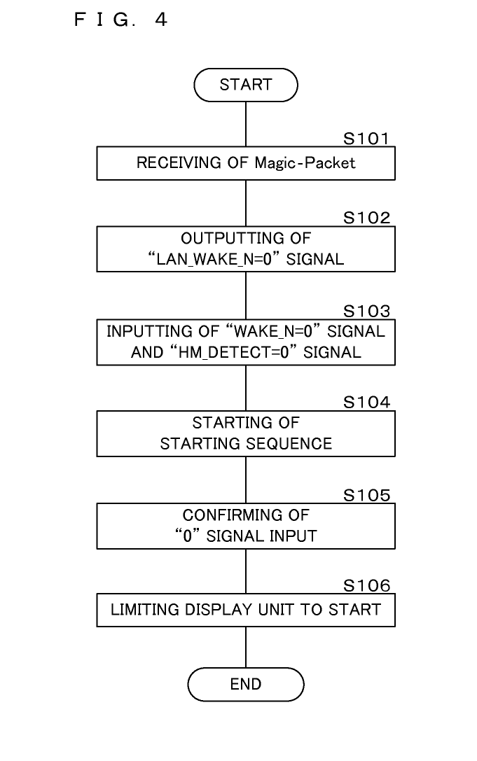

FIG. 4 is a flow chart describing processing when the LAN-Cnt 8 receives the Magic-Packet in the multi-function peripheral 100 according to the embodiment of the present invention. Hereinafter, the home key 51 will be described as an example of the hardware key with reference to FIG. 3.

For example, when the Magic-Packet relating to the firmware update is transmitted from the outside and the LAN-Cnt 8 receives the Magic-Packet through the network interface (step S101), the LAN-Cnt 8 outputs a “LAN_WAKE_N=0” signal indicating the fact to the south bridge 12 (step S102).

The “LAN_WAKE_N=0” signal is input only to one input terminal (input terminal 121) of the input terminals 121 and 122 of the south bridge 12.

As such, when the user does not operate the home key 51, the operation panel 5 outputs a “HM_KEY_N=1” signal representing the above-described fact. The “HM_KEY_N=1” signal is input to the input terminal 161 of the CPLD 16 and the CPLD 16 outputs a “CPLD_WAKE_N=Z” signal and a “HM_DETECT=0” signal through each of the output terminals 162 and 163 depending on the level of the signal. In other words, the “HM_DETECT=0” signal is continuously input to the input terminal 122 unless the home key 51 is not operated. Herein, Z is high impedance.

Thereby, a “WAKE_N=0” signal and the “HM_DETECT=0” signal are each input to the input terminals 121 and 122 of the south bridge 12 (step S103).

As such, when the WAKE_N=0 is input to the input terminal 121, that is, when “0” is input to the input terminal 121, the south bridge 12 detects the input of “0” and outputs the “WAKE_CNT” signal to the power supply circuit of the hardware relating to each function through the output terminal 124 so as to start a starting sequence (step S104).

When an OS starts, the CPU 14 confirms the input terminal 122 (the other input terminal) of the south bridge 12 through the output terminal 123. As described above, the “HM_DETECT=0” signal is continuously input to the input terminal 122 unless the home key 51 is not operated, and therefore, the input of “0” into the input terminal 122 is confirmed (step S105).

Therefore, the CPU 14 outputs the “ON/OFF_CNT” signal indicating the fact that the output (starting) of the display unit 6 is limited. Thereby, in the return, the starting of the display unit 6 is limited (step S106). Accordingly, like the firmware update, when the starting of the display unit 6 is not required, the starting of the display unit 6 is limited, and therefore the waste of power may be prevented.

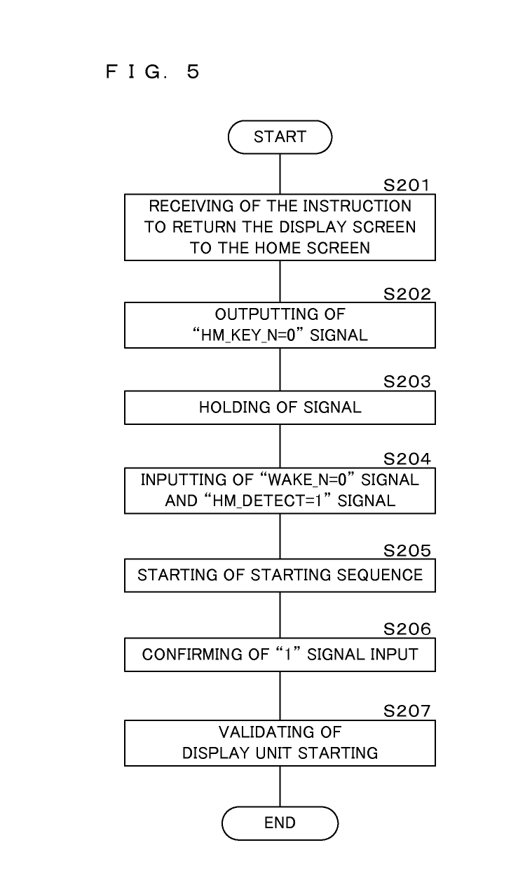

FIG. 5 is a flow chart describing the processing when the user operates any one of hardware keys of the operation panel 5 at the time of the power conserving mode in the multi-function peripheral 100 according to the embodiment of the present invention. Hereinafter, referring to FIG. 3, as the hardware key, the home key 51 will be described by way of example.

As described above, before the user performs an operation of pushing the home key 51, the home key 51 continuously outputs the “HM_KEY_N=1” signal. Meanwhile, when the user performs the operation of pushing the home key 51, and thereby the instruction to return the display screen of the display unit 6 to the home screen is received by the home key 51 (step S201), the home key 51 outputs the “HM_KEY_N=0” signal (step S202). Herein, 1=H/0=L. Thereby, the “0” signal is input to the input terminal 161 of the CPLD 16.

When the “HM_KEY_N=0” signal is input to the input terminal 161, that is, when the home key 51 is operated by the user, the CPLD 16 outputs different levels of signals to the south bridge 12 based on whether the current operation mode is the standby mode or the power conserving mode. For example, in the case of the power conserving mode, the CPLD 16 outputs the “CPLD_WAKE_N=Z” through the output terminal 162 and outputs the “HM_DETECT=1” signal through the output terminal 163.

In this case, the signal output to the south bridge 12 through the output terminal 163 is temporarily held by the signal holding unit 165 (step S203). Thereby, even when the home key 51 is the tact switch, for example, which cannot hold the turn on and/or off states, the output to the input terminal 122 of the south bridge 12 may be secured.

Thereby, the “WAKE_N=0” signal and the “HM_DETECT=1” signal are each input to the input terminals 121 and 122 of the south bridge 12 (step S204).

As such, when “0” is detected in the input terminal 121 by inputting the “WAKE_N=0” to the input terminal 121, the south bridge 12 outputs the “WAKE_CNT” signal to the power supply circuit of the hardware relating to each function through the output terminal 124 so as to start the starting sequence (step S205).

When the OS starts, the CPU 14 confirms the input terminal 122 (the other input terminal) of the south bridge 12 through the output terminal 123. As described above, when the home key 51 is operated, the “HM_DETECT=1” signal is input to the input terminal 122, and therefore the input of “1” into the input terminal 122 is confirmed (step S206).

In this case, the CPU 14 outputs the “ON/OFF_CNT” signal indicating the fact that the output (starting) of the display unit 6 is valid. Thereby, in the return due to the operation of the operation panel 5 by the user, the display unit 6 also starts (step S207).

As described above, the case in which the starting of the specific hardware is limited by the control instruction at return is described by way of example, but the present invention is not limited thereto. For example, the electric apparatus may include a specific operation mode in addition to the standby mode and the power conserving mode, and may be configured to be shifted into the specific operation mode by the control instruction at return.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1-5. (canceled)

6. An electric apparatus having operation states of a power conserving state in which power required for performing functions of the electric apparatus is limited and a normal state in which the power is not limited, the electric apparatus comprising:
a plurality of return instruction reception units configured to receive a return instruction indicating a return to the normal state; and
a control instruction output unit configured to output a control instruction relating to the return depending on which one of the return instruction reception units receives the return instruction.

7. The electric apparatus according to claim 6, comprising: a signal reception unit configured to receive signals from some of the plurality of return instruction reception units,
wherein the control instruction output unit has two input terminals to which the signal from the signal reception unit is input, and
the remaining return instruction reception units are connected to one of the two input terminals.

8. The electric apparatus according to claim 7, wherein the control instruction output unit is configured to output the control instruction based on the signal input to the other input terminal of the two input terminals when any one of the return instruction reception units receives the return instruction.

9. The electric apparatus according to claim 8, wherein the signal reception unit has a signal holding unit configured to hold a signal to be output to the other input terminal.

10. The electric apparatus according to claim 6, wherein the some of the return instruction reception units are configured to receive an instruction relating to execution of the functions.
